(19) United States
(12) Patent Application Publication
(10) Pub. No.: US 2008/0186201 A1
(43) Pub. Date: Aug. 7, 2008

(54) Intelligent System for Collecting Readings From Electric Meters

(75) Inventors: Yihua Wang, Shanghai (CN); Fan Zhang, Shanghai (CN); Hua Zhang, Shanghai (CN); Bin Hu, Shanghai (CN); Tianhua Rong, Shanghai (CN); Juanwei Zhong, Shanghai (CN)

Correspondence Address: GLOBAL IP SERVICES, 7285 W. Eagle Court, Winton, CA, 95388, US

(73) Assignees: SHANGHAI JIULONG ELECTRIC POWER (GROUP) CO., LTD., Shanghai (CN); Shanghai Jiulong Electric Power Technology Co., Ltd., Shanghai (CN)

(21) Appl. No.: 11/752,874

(22) Filed: May 23, 2007

(30) Foreign Application Priority Data
Feb. 1, 2007 (CN) 200710037071.9

(51) Int. Cl. G08C 15/06

(52) U.S. Cl. 340/870.03

(57) ABSTRACT

An intelligent system for collecting readings from electric meters, comprising the following components: several electric meters, a data concentrator connected to the electric meters, and a system main station connected to the concentrator wirelessly, in which: the electric meter for recording the consumed quantity of electricity by user, metering the quantity of electricity, measuring demand and making a fault recording, and supporting a time-sharing measurement and communication with the data concentrator by electric power carrier; a concentrator for providing intelligent relay management, implementing the communication with the electric meters and the system main station, the management of communication route of electric meters and the storage function of data; the system main station for realizing a stable bi-directional communication with the concentrator and several electric meters, reading data in the concentrator, collecting information on electric energy, synchronizing the time of the concentrator and the electric meters associated therewith, renewing time step tariff rate and meter parameters of the electric meters. Bi-directional stable communication between the main station and the intelligent electric meters and collection of electrical energy information and the adjustment of parameters of electric meters can be realized by transmission medium in the present invention. The system of the present invention features complete functions, stable user-friendly operation interface, and has good expansion potential. Therefore this system is an important technical means for user-side management. The present invention greatly improves management efficiency and economic benefits in the electrical power department.

### CROSS REFERENCE TO THE RELATED PATENT APPLICATION

This patent application claims the priority of the Chinese patent application No. 200710037071.9, filing date of Feb. 1, 2007.

### FIELD OF THE INVENTION

The present invention relates to an intelligent system for collecting readings from electric meters, particularly to an intelligent system which can realize stable bi-directional communication between the main station and the intelligent electric meters.

### BACKGROUND OF THE INVENTION

The existing intelligent system for collecting readings from electric meters can accomplish only unidirectional data collection from the electric meters. Such unidirectional data collection can obtain less than satisfactory data content, and the reliability of data collection is unsatisfactorily low.

However, the development of technology in response to market requirements, to realize bi-directional communication between the electric meters and the main station so that not only being able to accomplish unidirectional data collection of the readings from the electric meters, but also being able to accomplish the adjustment and control of the parameters of electric meters and to obtain more data content with a high reliability of collection, became the objects of research by the present applicant.

### SUMMARY OF THE INVENTION

The object of the present invention is to provide an intelligent system for collecting readings from electric meters, which system can realize bi-directional communication between the electric meter and the main station. This intelligent system can not only accomplish the unidirectional collection of readings from electric meters, but also can accomplish the adjustment and control of the parameters of the electric meters. At the same time, the system can obtain more data content, and the reliability of data collection is rather high.

This intelligent system for collecting readings from electric meters provided by the present invention is characterized in that it comprises several electric meters, a data concentrator connected to the electric meters, and a system main station connected to the concentrator wirelessly. In this system, the electric meter records the consumed quantity of electricity by user, metering the quantity of electricity, measuring demand and making a fault recording, supporting a time-sharing measurement and communicating with the data concentrator by electric power carrier.

In the above-mentioned intelligent system, each electric meter comprises a built-in electric power carrier communication module.

In the above-mentioned intelligent system, the concentrator is composed of a carrier communication module and a connected central processor. The carrier communication module has the ability to complete the transmission and reception of a carrier signal, process communication protocol, build up and maintain the carrier network and has the self-adaptive function of carrier communication. The central processor provides a readout of the data of electrical energy, demand, voltage, electrical current and electrical power of the electric meters, a disposition of electric meters' multiple charge rate parameters, a synchronization of the clocks of the electric meters, the building up of a carrier communication network and automatic optimization, management of the electric meter associated the with the concentrator, storage of data, the communication with the system main station, the support of local communication and the treatment of protocol.

In the above-mentioned intelligent system, the communication between said central processor and said system main station is accomplished by means of a Modem or GPRS Modem.

In the above-mentioned intelligent system, the system main station comprises a main control console, a database and an application server which are connected to the main control console, a WEB server connected to said database and a communication front-end connected to said application server.

In the above mentioned intelligent system, the main control console comprises a safety management module, a data maintenance module connected to a safety management module, a transmitting command module, a data inquiry module, a statistics and analysis module and a WEB inquiry module; said safety management module can accomplish control of access to the rest of the modules mentioned above.

In the above-mentioned intelligent system, the safety management module is used in system login, role management, user management, distributing competencies to the role and the user, examining the operating log file, revising login ciphers, switching users and a locking program.

In the above-mentioned intelligent system, the data maintenance module is used in the maintenance of code, protocol, tariff rate and the concentrator/electric meters.

In the above mentioned intelligent system, the transmitting command module is used in plan definition of the system for collecting readings of the electric meters, transmitting commands to the concentrator, transmitting commands to the electric meters, time correction, inquiring about transmitted commands and executing a log file of the commands.

In the above mentioned intelligent system, the data inquiry module is used in the maintenance of the inquiry collection, executing an inquiry, defining a temporary inquiry, inquiring about user information, inquiring about the electric meter which has not obtained a monthly quantity of electricity settling account, inquiring about the electric meter which has no obtained integer or integral point quantity of electricity, inquiring about the electrical meter which has not obtained on a quarterly basis the electrical energy, inquiring about the demand of the electric meter and inquiring about missing data.

In the above mentioned intelligent system, the statistical analysis module is used for statistics of the number of the concentrator, statistic of the number of the electrical meters, statistics of integral point electrical quantity, daily quantity of electricity, monthly quantity of electricity statistics and quarterly electrical energy, analysis of anomalous electrical quantity used and the relationship between temperature and the electricity used.

In the above-mentioned intelligent system, the WEB inquiry module is used in system login, inquiring about equipment, inquiring about user information, inquiring about data and related statistics.

In the above mentioned intelligent system, the data inquiry and statistics comprise the statistics of the number of the newly built-up or installing/put into use or commissioning concentrators, according to the time intervals, statistics of newly built-up/put into use electrical meters, the statistics of the number of concentrators and the number of electrical meters according to regions, inquiring about daily maximum hours of electrical quantity used, inquiring about the integer quantity of electricity used by the electrical meter, inquiring about daily used quantity of electricity, mean daily used quantity of electricity of the electric meters, inquiring about monthly quantity of electricity used and inquiring about quarterly maximum demand data.

Because the above-mentioned technical scheme is used, the bi-directional stable communication between main station and the intelligent electric meters and collection of electrical energy information and the adjustment of parameters of electric meters (channels of wireless, wired radio, electric power wire carrier etc.) can be realized by a transmission medium.

The system of the present invention features complete functions, stable operation user-friendly interface, and has good expansion possibility; therefore the system is an important technical means for user-side management. The present invention greatly improves management efficiency and economic benefit to the electrical management department.

### BRIEF DESCRIPTION OF THE DRAWINGS

Through the following description of an embodiment of the intelligent system of the present invention in conjunction with the accompanying drawings, the object, structural characteristics and advantages can be further understood from the drawings.

FIG. 1 is the block diagram of the intelligent system for collecting readings from electric meters.

FIG. 2 is a schematic diagram of the structure of the electric meter in the present invention.

FIG. 3 is a schematic diagram of the structure of the concentrator of the present invention.

FIG. 4 is a data flow chart of the intelligent system of the present invention.

FIG. 5 is a diagram of the main station of the present invention.

FIG. 6 is a function block diagram of the main control console of the main station of the present invention.

### DETAILED DESCRIPTION OF THE INVENTION

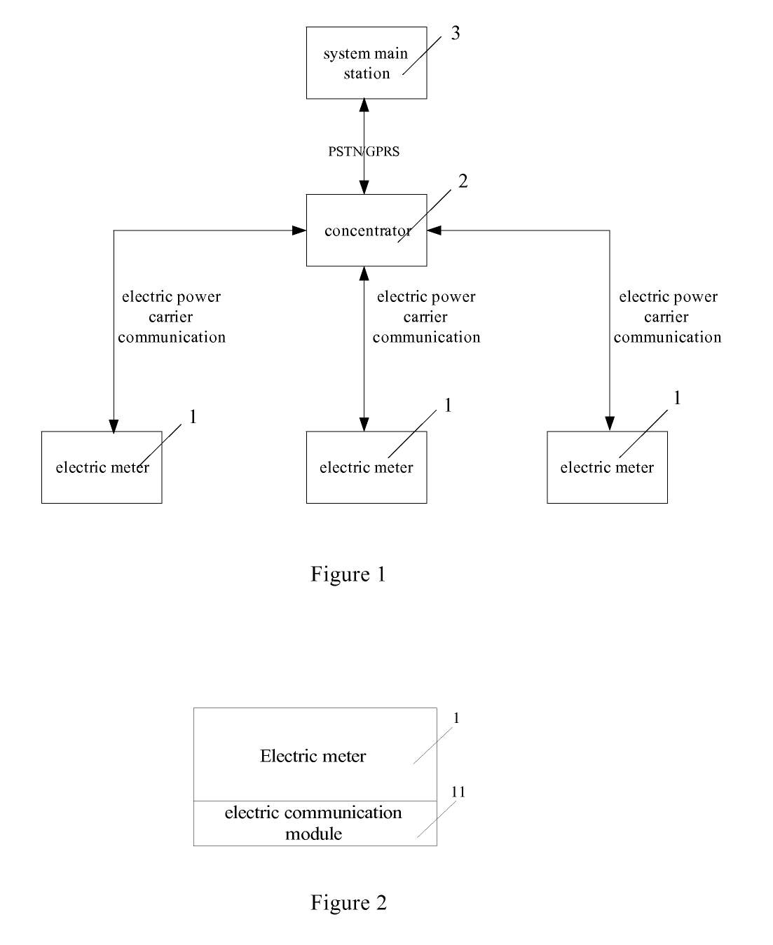

As is shown in FIG. 1, the intelligent system for collecting readings from the electric meters of the present invention comprises several electric meters (1), a concentrator (2) connected with several electric meters, and a system main station (3) connected by means of a wireless network.

The electric meter (1) is used to collect the quantity of electricity used by the user, to measure the quantity of electricity and demand, and to make a fault recording, as well as to support time-division measurement, and to communicate with the data concentrator through an electric power carrier. Full electronic single-phase three-wire multiple charge or tariff rate electric energy meter DDSIF 501 can be used, and an electric power carrier communication module is inserted into the electric energy meter (see FIG. 2).

The concentrator 2 is used in intelligent relay management, to accomplish the function of communication with the electric meters, communication with the system main station, communication route management of the electric meters, and the function of the storage of data etc. The concentrator can automatically combine the network and optimize the route, i.e. when the effect of communication between the concentrator and electric meters is not good, the contractor can automatically accomplish the re-establishment and optimization of the network.

The SMS DC-2000 type electric power wire carrier data concentrator can be used.

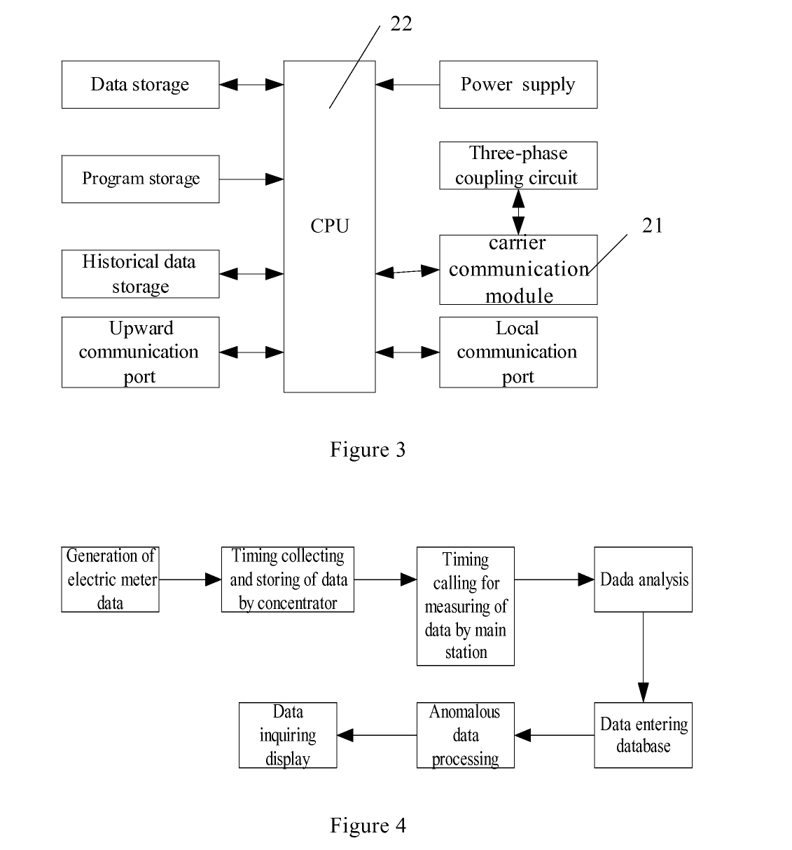

Please refer to FIG. 3. The concentrator (2) is composed of a carrier communication module (21) and a central processing unit (22) connected to it.

The carrier communication module (21) is used to accomplish the transmission and reception of the carrier signal, the treatment of communication protocol, the establishment and maintenance of the carrier network and the self-adaptive function of carrier communication.

The central processing unit (22) is used to accomplish the data reading of electric energy, demand, voltage, electric current of the electric meters etc. to set up multiple charge rate parameters and the synchronization of the clocks of the electric meters, the establishment and automatic optimization of the carrier communication network, the management of the electric meters, the storage of data, and communication with the system main station by means of Modem or GPRS Modem, used to support local communication and the treatment of communication protocol.

The main station (3) is used through a transmission medium (modem or GPRS modem channels) to realize stable bi-directional communication with the concentrator and several electric meters, to read the data in the concentrator, to collect the information on electrical energy, to correct the time of the concentrator and electric meters associated therewith, and to renew the time tariff rate and parameters of the electric meters connected to the concentrator.

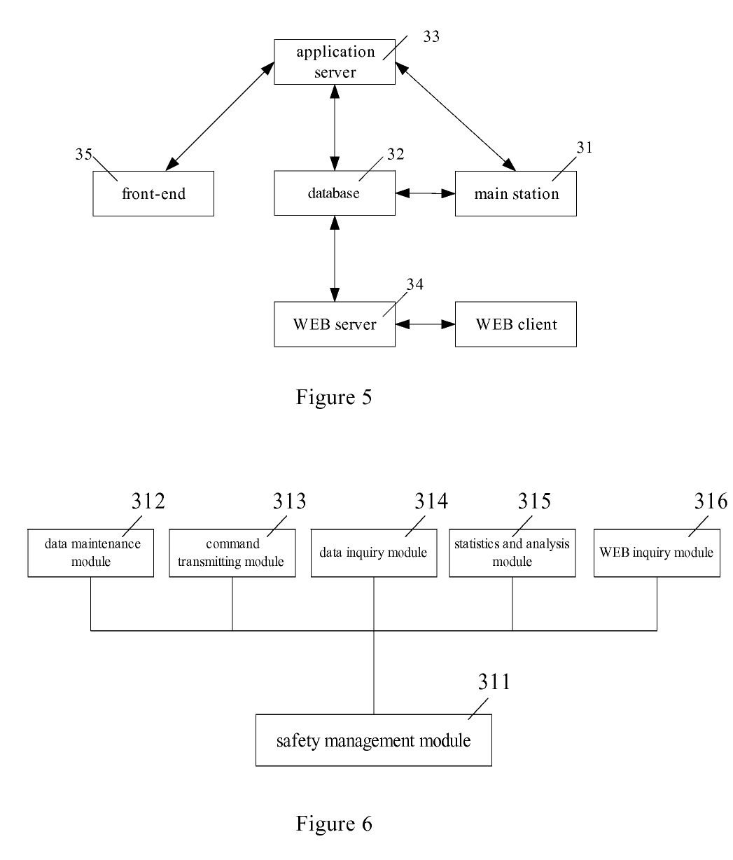

Please refer to FIG. 5. The main station comprises a main control console (31), a database (32) connected to the main station (31), an application server (33), WEB server (34) connected to the database (32) and a communication, front-end (35) connected to the database (32).

The structure in the main station is an advanced one, and has a data interface with open standard, communication being reliable, the load being equalized.

Please refer to FIG. 6. The main control console (31) comprises a safety management module (311), a data maintenance module (312) connected to the safety management module (311), a command transmitting module (313), a data inquiry module (314), a statistics and analysis module (315) and WEB inquiry module (316). The safety management module (311) can realize access competence control of the remaining modules.

The safety management module (311) is used in system login, role management, user management, distributing the competence to roles and users, examining the operation log file, retiring a login cipher, switching users and locking a program.

Data maintenance module (312) is used in code maintenance, protocol maintenance, collection point disposed pattern plate maintenance, tariff rate maintenance and concentrator maintenance/electric meter maintenance.

Command transmitting module (313) is used in plan definition for collecting readings from the electric meters, transmitting commands to the concentrator, transmitting commands to electric meters, correcting time, inquiring about issued commands, and command execution log file.

Data inquiry module (314) is used for inquiry on collection maintenance, inquiring about execution, temporary inquiring about definition, user information inquiry and inquiring about electric meters which have not recorded the monthly used quantity of electricity. It is also used for inquiring about electric meters which have not obtained the integral point quantity of electricity nor seasonal electrical energy and demand as well as inquiring about mixing data. Data on which meters have not obtained the integral point quantity of electricity statistic and analysis module (315) are used in the statistics of the number of the concentrators and the electric meters in many of the intelligent systems, as are statistics of the integral point quantity of electricity, statistics of daily quantity of electricity, statistics of monthly quantity of electricity, statistics of quarterly electrical energy, analysis of electricity anomalously used, as well as analysis of the relationship between temperature and the used quantity of electricity.

WEB inquiring module (316) is used for system login, inquiries on equipment, user information, data inquiry and statistics.

The equipment inquiry comprises information inquiry about the front-end, information inquiry on concentration and information inquiry about electric meters.

The user information inquiry comprises information inquiry of respective users and regions, data inquiry and statistics including time statistics of the number of the concentrators newly installed/commissioned according to time intervals, inquiring about the number of newly installed/commissioned electric meters according to time intervals, statistics of the number of concentrators according to regions, statistics of the number of electric meters according to regions, inquiry about daily maximum hour quantity of electricity used, inquiry about used quantity of electricity of electric meters, inquiry about the quantity of electricity, inquiry about daily quantity of electricity used, inquiry about daily averaging quantity of electricity used by electric meters, inquiry about the monthly quantity of electricity used and inquiry about quarterly maximum demand.

The data flow chart of the intelligent system for collecting readings from electricity meters applicable to the present invention is:

Generating the electric meter data→timing collecting and storing of data by concentrator→timing calling for measuring of data by main station→data analysis→data entering database→anomalous data processing→data inquiring display.

An important note: the above description is intended to describe but not to limit the technical scheme of the present invention. Although the present invention is explained according to the above-mentioned embodiment, skilled persons in the field of the present invention should understand that any revisions in, or replacements of items in the above described invention mention are possible, and any revision of partial replacement without departing from the sprit and range of the present invention are covered by and falling in the range of the appended claims of the present invention.

What is claimed is:

1. An intelligent system for collecting readings from electric meters, comprising several electric meters, a data concentrator connected to the electric meters, and a system main station connected to the concentrator in a wireless connection, wherein:
(a) the electric meters used for recording the consumed quantity of electricity by user, metering the quantity of electricity, measuring demand and making fault recordings, and supporting time-sharing measurement and communicating with the data concentrator by electric power carrier;
(b) the concentrator used for providing intelligent relay management, implementing communication with the electric meters and the system main station, management of communication route of the meters and function of data storage; and
(c) the system main station used for realizing stable bi-directional communication with the concentrator and the several electric meters, reading data in the concentrator, collecting information on electric energy, synchronizing time of the concentrator and the associated electric meters, renewing time step tariff rate and parameters of the electric meters.

2. The intelligent system according to claim 1, wherein said electric meters each comprises a built-in electric power carrier communication module.

3. The intelligent system according to claim 1 wherein said concentrator includes a carrier communication module and a central processor connected thereto, in which:
the carrier communication module functions for completing transmission and reception of carrier signal, treatment of communication protocol, buildup and maintenance of the carrier network and self-adaptive function of the carrier communication,
the central processor functions for completing readout of the data of electrical energy, demand, voltage, electrical current and electrical power of the electric meters, disposition of the electric meters' multiple charge rate parameters, synchronization of clocks of the electric meters, building up of the carrier communication network and automatic optimization, management of the electric meters associated with the concentrator, storage of the data, communication with the system main station, support of the local communication and treatment of the protocol.

4. The intelligent system according to claim 3, wherein the communication between said central processor and said system main station is accomplished by means of a Modem or a GPRS Modem.

5. The intelligent system according to claim 3, wherein said system's main station comprises a main control console, a database and an application server which are connected to the main control console, a WEB server connected to said database and a communication front-end connected to said application server.

6. The intelligent system according to claim 5, wherein said main control console comprises a safety management module, a data maintenance module connected to said safety management module, a transmitting command module, a data inquiry module, a statistic and analysis module and a WEB inquiry module; said safety management module can realize control on access competence of the other above-mentioned modules.

7. The intelligent system according to claim 6, wherein said safety management module is used in system login, role management, user management, distributing competences to the role and the user, examining the operating log file, revising login ciphers, switching users and locking program.

8. The intelligent system according to claim 6, wherein said data maintenance module is used in the maintenance of code, protocol, tariff rate, the concentrator/electric meters.

9. The intelligent system according to claim 6 wherein said transmitting command module is used in plan definition of the system for collecting readings of electric meters, transmitting commands to the concentrator, transmitting commands to the electric meters, time correction, inquiring about transmitted commands and execution of a log file of the commands.

10. The intelligent system according to claim 6, wherein said data inquiry module is used in maintenance of inquiry collection, executing an inquiry, defining a temporary inquiry, inquiring about user information, inquiring about the electric meter which has not achieved the monthly quantity of the electricity settling account, inquiring about the meter which has no obtained an integer or integral point quantity of electricity, inquiring about the electrical meter which has not obtained on a quarterly basis electrical energy, inquiring about the demand of the electric meter and inquiring about the missing data.

11. The intelligent system according to claim 6, wherein said statistical analysis module is used for statistics of the number of the concentrator, statistics of the number of the electrical meters, statistics of integral point electrical quantity, daily quantity of electricity, monthly quantity of electricity statistics and quarterly electrical energy, analysis of anomalous electrical quantity used and the relationship between temperature and the electricity used.

12. The intelligent system according to claim 6, wherein said WEB inquiry module is used in system login, inquiring about equipment, inquiring about user information and inquiring about data and its statistics.

13. The intelligent system according to claim 12, wherein said data inquiry and statistics comprise the statistics of the number of the newly built-up or installed/commissioned concentrators, according to the time intervals, statistics of newly installed/commissioned electrical meters, the statistics of the number of concentrators and the number of electivity meters according to regions, inquiring about daily maximum hours of electrical quantity used, inquiring about the integer point quantity of electricity used by electrical meters, inquiring about daily used quantity of electricity, mean (average) daily used quantity of electricity of the electric meters, inquiring about monthly quantity of electricity used and inquiring about quarterly maximum demand data.
